(19) United States
(12) Patent Application Publication
(10) Pub. No.: US 2003/0110283 A1
(43) Pub. Date: Jun. 12, 2003

(54) Apparatus for providing and transmitting information over network and method therefor

(76) Inventor: Jae Wook Lee, Daejon (KR)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/057,385

(22) Filed: Jan. 23, 2002

(30) Foreign Application Priority Data
Dec. 7, 2001 (KR) 01-77424

(51) Int. Cl. G06F 15/16

(52) U.S. Cl. 709/233; 709/234

(57) ABSTRACT

An information providing system including an information providing server, which stores display information and bandwidth information requested for transmission of the display information, and transmits the display information and the bandwidth information in response to the request of the user, an information transmission server, which performs bandwidth negotiation and bandwidth reservation based on information on available bandwidth on the network using the bandwidth information transmitted from the information providing server and requests buffering for bandwidth that cannot be reserved, and a terminal which receives the display information from the information providing server in response to the buffering request received from the information transmission server, buffers the display information, and displays the display information transmitted from the information providing server over the network together with the buffered display information after call setup.

### BACKGROUND OF THE INVENTION

1. Field of the Invention

The present invention relates to an apparatus for generating and storing information to be provided to a user, effectively transmitting the information over a network, and displaying the information in a system for providing content information and its additional information, which the user desires to receive, to the user in a remote place.

2. Description of the Related Art

Non-real-time streaming services, such as video-on-request (VOD) systems, provide multimedia content information stored in a server to users over a network as streaming services in response to the request of the users. In order to realize such VOD systems, an information provider, a service provider, a transmission system provider, and a terminal are necessary. The information provider includes servers which are capable of generating, storing, and transmitting information. The service provider may be a TV broadcasting station. The transmission system provider transmits information requested by the service provider to a plurality of TV service subscribers at high speeds over a network. The terminal receives service information supplied from the transmission system provider and displays the service information.

Services, which can be realized by VOD systems, may include a movie-on-demand (MOD) service; a news-on-demand (NOD) service, which can immediately provide a news summary or a news headline for every field; a remote shopping service, which can provide image catalogs of products and various image services to users so that the users can look through virtual showcases; a remote medical diagnosis service, which can obtain diagnosis and prescription data by analyzing and processing X-ray images and other relevant data of an end user and transmit the data to the other end user; a remote game service; a home banking service, which can provide general banking services to users; a video conference service; a convention service, which allows users to enter into a business relationship with one another based on information provided by the users; and an internet service which can provide access to the Internet.

The VOD systems are divided into two different types including a real-time VOD system and a non-real-time VOD system. For example, the remote medical diagnosis service corresponds to a real-time VOD system. A movie program service corresponds to a non-real-time VOD system.

The non-real-time VOD system is comprised of a server, a transmission system, and a terminal. If a user requests a predetermined movie to the server by manipulating a certain application program included in the terminal, the server takes bit streams previously generated and stored in a database, in which video data, audio data, and text data of the requested movie are mixed together, from the database and transmits the bit streams to the terminal via the transmission system. The terminal stores all the bit streams and then displays the bit streams using an output device. Alternatively, the terminal may display the bit streams while buffering.

However, the bandwidth resources of a communication network for transmitting multimedia content have physical limitations. Thus, in the case of a streaming service, which requires a large storage capacity, if an appropriate network bandwidth is not reserved and data are not buffered well, multimedia information may be cut-off in a user's terminal. In addition, the appropriate reservation of a network bandwidth is performed based on information on the bandwidth requested by the server at a call setup. However, the amount of bandwidth used by the multimedia content is time-dependent, and thus it is difficult to appropriately and precisely reserve the requested bandwidth. If a bandwidth wider than the requested bandwidth is unnecessarily reserved to prevent information from being cut off in a terminal, the resources of a communication network are wasted, and thus the performance and utilization rate of the communication network may deteriorate.

### SUMMARY OF THE INVENTION

To solve the above-described problems, it is an object of the present invention to provide an apparatus and a method for providing high quality information services to users with the use of a limited communication network bandwidth and thus preventing information from being cut off, and a terminal, which uses the information services.

Accordingly, to achieve the above object, there is provided an information providing system including an information providing server, which stores display information and bandwidth information requested for transmission of the display information, and transmits the display information and the bandwidth information in response to the request of the user, an information transmission server, which performs bandwidth negotiation and bandwidth reservation based on information on available bandwidth on the network using the bandwidth information transmitted from the information providing server and requests buffering for bandwidth that cannot be reserved, and a terminal which receives the display information from the information providing server in response to the buffering request received from the information transmission server, buffers the display information, and displays the display information transmitted from the information providing server over the network together with the buffered display information after call setup.

According to another aspect of the present invention, there is provided an information providing device including an information generation unit which generates display information and bandwidth information requested for transmission of the display information, an information extraction unit which extracts display information to be provided corresponding to a service requested by a user and bandwidth information requested for the service request, bandwidth information transmission unit which transmits the requested bandwidth information over a network and receives information on the results of bandwidth reservation, and a display information transmission unit which transmits the display information over the network based on the information on the results of bandwidth reservation.

Also, the present invention provides an information transmission device including a bandwidth information transmission unit which receives requested bandwidth information necessary for display information to be transmitted over a network and transmits information on the results of bandwidth negotiation with respect to the requested bandwidth information, a bandwidth negotiation unit which determines whether or not bandwidth can be reserved by comparing the requested bandwidth information with information on available bandwidth over the network and requests a terminal to perform data buffering if there is bandwidth that cannot be reserved over the network, a bandwidth reservation unit which, if possible, reserves bandwidth requested by the requested bandwidth information and, if not possible, reserves the bandwidth requested by the requested bandwidth information except for bandwidth requested to be buffered in the terminal, and a display information transmission unit which transmits display information to be buffered in the terminal and transmits display information to the terminal with the bandwidth reserved by the bandwidth reservation unit after call setup.

Alternatively, the present invention provides a terminal, which receives information over a network in response to the request of a user, the terminal including a bandwidth negotiation unit which determines whether or not data requested to be buffered can be buffered if bandwidth reservation is not successful over the network in response to the request of the user and transmits the result of the determination, a display information transmission unit which receives and stores display information necessary for the requested buffering, and receives and stores display information necessary for providing a service after call setup, and an output unit which extracts and outputs the stored display information.

According to another aspect of the present invention, there is provided a method of providing information including the steps of receiving a request for providing an information service from a user's terminal, extracting display information to be provided to a user corresponding to the service request and bandwidth information requested for transmission of the display information, determining whether or not it is possible to reserve bandwidth by comparing the requested bandwidth information with information on available bandwidth over a network, providing the service by transmitting the display information to the user's terminal after call setup, if bandwidth reservation is successful, requesting the user's terminal to perform data buffering and transmitting a part of the display information to the user's terminal so as to be buffered, if it is determined that bandwidth that cannot be reserved exists, and providing the service by setting up a call with bandwidth that can be reserved over the network after the buffering is completed and transmitting the rest of the display information to the user's terminal.

Also, the present invention provides a method of providing information including (a) receiving content data for providing a service, (b) generating and storing display information and bandwidth information corresponding to the amount of display information requested at each time span, (c) extracting bandwidth information necessary for the service in response to a service request and requesting a network to negotiate bandwidth, and (d) receiving information on the results of the bandwidth negotiation from the network and transmitting display information corresponding to the service using the reserved bandwidth over the network.

### BRIEF DESCRIPTION OF THE DRAWINGS

The above objects and advantages of the present invention will become more apparent by describing in detail a preferred embodiment thereof with reference to the attached drawings in which:

FIG. 1 is a block diagram illustrating the structure of a communication system according to the present invention;

FIG. 2 is a block diagram illustrating the structure of an information providing server shown in FIG. 1;

FIG. 3 is a block diagram illustrating the structure of an information transmission server shown in FIG. 1;

FIG. 4 is a block diagram illustrating the structure of a terminal shown in FIG. 1;

FIGS. 5A and 5B are flowcharts illustrating the operations of an information providing server;

FIG. 6 is a flowchart illustrating operation of an information transmission server;

FIG. 7 is a flowchart illustrating operation of a terminal;

FIG. 8 is a diagram illustrating operation of bandwidth information generation unit of the information providing server shown in FIG. 2;

FIG. 9 is a diagram illustrating operation of bandwidth negotiation unit of the information transmission server shown in FIG. 3; and

FIG. 10 is a flowchart illustrating operation of the communication system of FIG. 1.

### DETAILED DESCRIPTION OF THE INVENTION

Hereinafter, the present invention will now be described more fully with reference to the accompanying drawings, in which a preferred invention is shown.

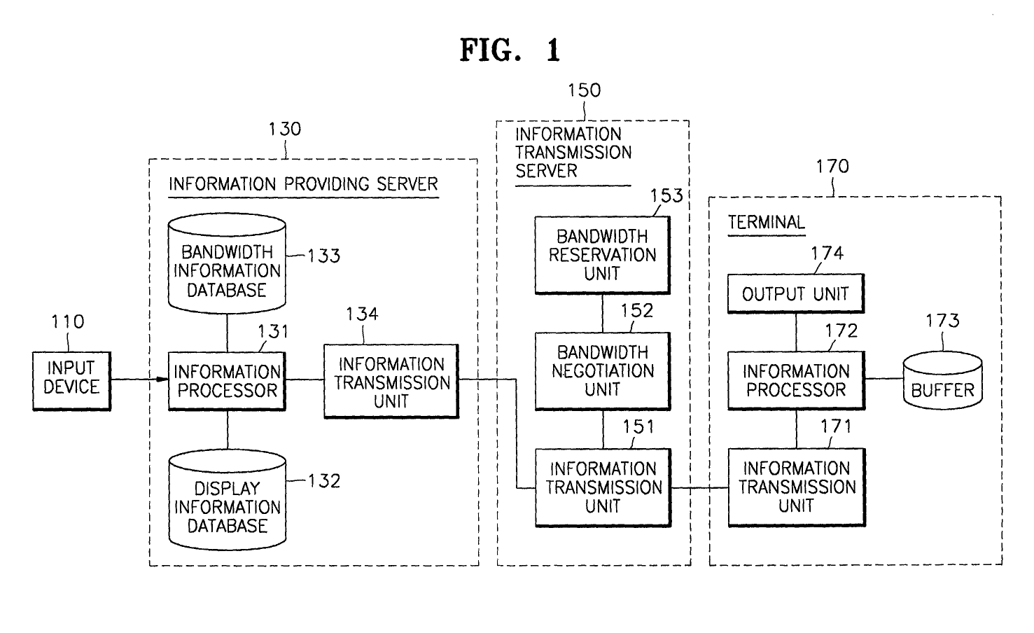

FIG. 1 is a block diagram illustrating the structure of a communication system according to a preferred embodiment of the present invention. An information providing server 130 generates display information on multimedia content input from an input device 110 and additionally generates bandwidth information obtained by computing the amount of bandwidth requested by the display information at each time span. An information transmission server 150 receives information on requested bandwidth necessary for a predetermined service from the information providing server 130 in a step of setting up a call and appropriately and precisely performs bandwidth negotiation and reservation on a communication network based on information on available bandwidth. A terminal 170 requests a service to the information providing server 130 and appropriately and precisely buffers display information, which belongs to bandwidth that cannot be reserved by the information transmission server 150. In FIG. 1, a server for providing information to users and a server for reserving network bandwidth to be requested to transmit information from the information providing server to users are illustrated as separate servers. However, the two servers may be integrated into one server or a computer. Alternatively, some functions of the two servers may be separated and thus may be performed by a different computer.

In the present invention, in order to effectively perform a service with the use of a non-real-time multimedia content streaming communication system having a large storage capacity, display information for display and information on requested bandwidth, which varies depending on the amount of display information varying at each time span, are generated and stored when multimedia data are generated, and information on bandwidth requested at each time span is transmitted to the information providing server 150 when a call is set up. Accordingly, it is possible to appropriately and precisely reserve bandwidth.

The information providing server 130 generates display information corresponding to multimedia content for a streaming service and information on requested bandwidth, which is obtained by computing bandwidth requested for each span of time, are generated. The information transmission server 150 appropriately and precisely performs bandwidth negotiation and reservation at call setup based on the information on bandwidth requested for each span of time, which is received from the information providing server 130. The terminal 170 buffers an appropriate amount of display information in order to compensate for bandwidth that cannot be reserved based on the results of the bandwidth negotiation and allows a high quality service to be seamlessly provided to users.

The present invention has been described above, taking a non-real-time VOD system, which is most widely used, as an example. However, the present invention may also be applied to non-real-time communication devices or methods, which are capable of providing multimedia content in a non-real-time manner.

Referring to FIG. 1, the communication system according to the present invention includes the information providing server 130 for providing multimedia content, the information transmission server 150 (a network unit) for providing network bandwidth for a multimedia service and transmitting information on the service, and the terminal 170 for displaying the multimedia service information received from the information transmission server 150. The information providing server 130 receives data from an input device 110, such as a video recorder, which generates the multimedia content as digital information.

The information providing server 130 includes an information processor 131 for converting/compressing/storing multimedia information received from the input device 110, a display information database 132 and a bandwidth information database 133 for storing the multimedia information and bandwidth information, respectively, processed by the information processor 131, and communicates with the information transmission server 150.

The information transmission server 150, which may be comprised of at least one physical transmission device, includes an information transmission unit 151 which can send and receive bit streams; a bandwidth negotiation unit 152 which negotiates with the information providing server 130 and the terminal 170 for network bandwidth requested for a service, based on information on available bandwidths; and a bandwidth reservation unit 153 which reserves network bandwidth based on the results of the bandwidth negotiation.

The terminal 170 includes an information transmission unit 171, which can send/receive information to/from the information transmission server 150; an information processor 172, which processes information received from the information transmission server 150; a buffer 173, which is a medium for temporarily storing display information; and an output unit 174, which displays information drawn from the buffer 173 to users.

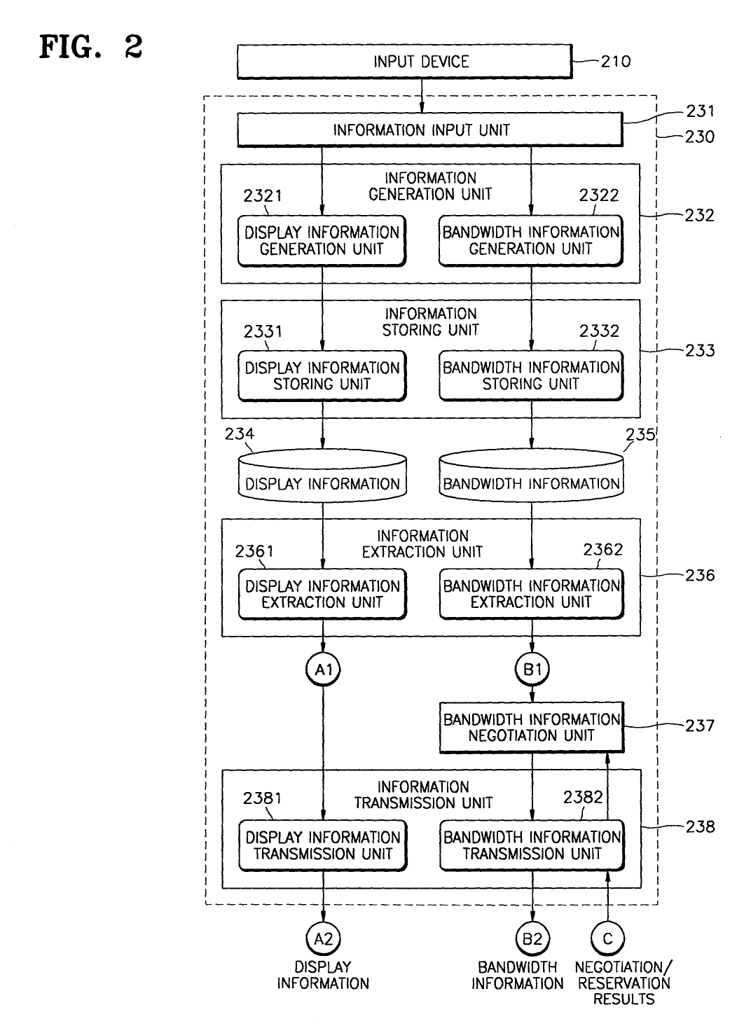

FIG. 2 is a block diagram illustrating the structure of the information providing server 130 shown in FIG. 1. Referring to FIG. 2, the information providing server 230 includes an information input unit 231, which converts a signal input from an input device 210 into a digital signal; an information generation unit 232 comprised of a display information generation unit 2321, and a bandwidth information generation unit 2322, which generate display information and bandwidth information, respectively, from the output signal of the information input unit 231; an information storing unit 233 comprised of a display information storing unit 2331, which controls the display information to be stored in a display information database 234, and a bandwidth information storing unit 2332, which controls the bandwidth information to be stored in a bandwidth information database 235; an information extraction unit 236 comprised of a display information extraction unit 2361, which extracts display information A1 from the display information database 234, and a bandwidth information extraction unit 2362, which extracts bandwidth information B1 from the bandwidth information database 235; a bandwidth information negotiation unit 237, which performs bandwidth negotiation using the bandwidth information B1 extracted by the information extraction unit 236 based on the results of the bandwidth negotiation and reservation received from the information transmission server 170; and an information transmission unit 238 comprised of a display information transmission unit 2381, which transmits display information A2, and a bandwidth information transmission unit 2382, which transmits bandwidth information B2. The bandwidth information transmission unit 2382 receives information (C) on the results of the bandwidth negotiation and reservation from the information transmission server 170.

The input device 210, such as a video recorder, converts multimedia content into digital information and inputs the digital information to the information input unit 231. The information generation unit 232 includes the display information generation unit 2321, which generates display information on multimedia content to be displayed on a display device using the digital information transmitted from the information input unit 231, and the bandwidth information generation unit 2322, which generates information on bandwidth requested at each span of time for bandwidth negotiation and reservation, which is provided to the information transmission server 150 in a step of setting up a call.

The display information generated by the information generation unit 232 is stored in the display information database 234 by the display information storing unit 2331, and the bandwidth information generated by the information generation unit 232 is stored in the bandwidth information database 235 by the bandwidth information storing unit 2332.

In a step of setting up a call in response to the service request of a user, the bandwidth information extraction unit 2362 of the information extraction unit 236 extracts bandwidth information on display information requested to be provided to the user as a service from the bandwidth information database 235 and transmits the requested bandwidth information to the bandwidth information negotiation unit 237.

The bandwidth information negotiation unit 237 transfers the bandwidth information to the bandwidth information transmission unit 2382 to be transmitted to the information transmission server 170.

The bandwidth information transmission unit 2382 transmits the bandwidth information to the information transmission server 170. The bandwidth information transmission unit 238 receives information on bandwidth negotiation and the results from the information transmission server 170 and transmits the information to the bandwidth information negotiation unit 237. The bandwidth information negotiation unit 237 performs an appropriate negotiation process based on the information on the bandwidth negotiation and reservation and their results, which are received from the information transmission server 170. If bandwidth negotiation is successfully performed by the bandwidth information negotiation unit 237 in the step of setting up a call, the display information extraction unit 2361 of the information extraction unit 236 extracts display information from the display information database 234 and transfers the display information to the display information transmission unit 2381 to be transmitted to the information transmission server 170, thereby performing a service.

In the information providing server 230, the steps of storing display information and bandwidth information in their respective databases 234 and 235 using the information input unit 231, the information generation unit 232, and the information storing unit 233 are preferably performed in an off-line state, and the steps of processing and sending/receiving the information stored in the databases 234 and 235 using the information extraction unit 236, the bandwidth information negotiation unit 237, and the information transmission unit 238 are preferably performed in an online state.

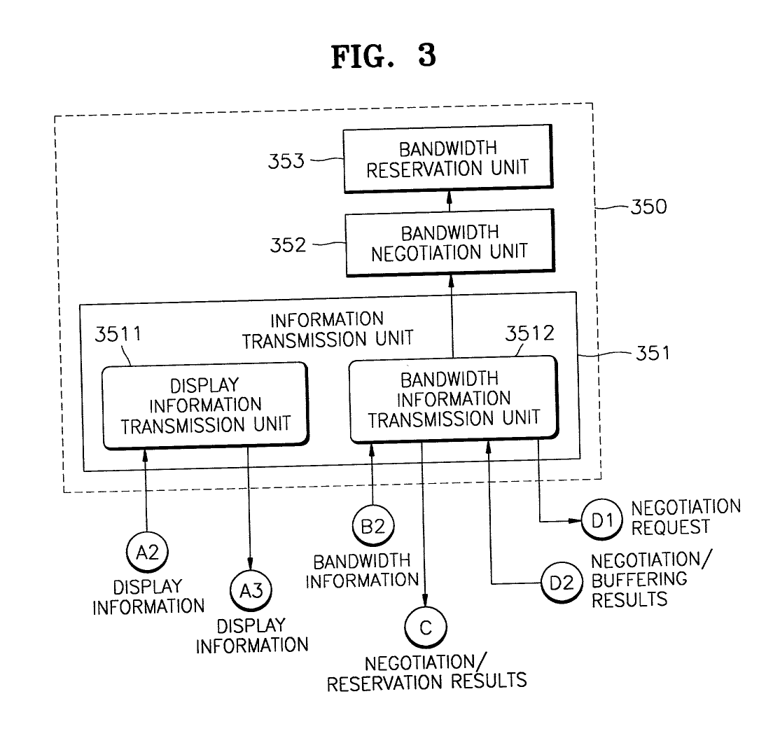

FIG. 3 is a block diagram illustrating the structure of the information transmission server 150 shown in FIG. 1. Referring to FIG. 3, the information transmission server 350, which may be comprised of at least one physical transmission device, includes an information transmission unit 351 which can send/receive bit streams; a bandwidth negotiation unit 352, which performs bandwidth negotiation with the information providing server 130 and the terminal 170 based on information on available bandwidths; and a bandwidth reservation unit 353, which reserves network bandwidth based on the results of the bandwidth negotiation.

In a step of setting up a call, a bandwidth information transmission unit 3512 of the information transmission unit 351 receives the requested bandwidth information (B2) necessary for bandwidth negotiation from the information providing server 130 and transfers the bandwidth information (B2) to the bandwidth negotiation unit 352. The bandwidth negotiation unit 352 determines whether or not bandwidth, which allows a service to be provided, exists by comparing the amount of bandwidth requested by the information providing server 130 with the amount of available bandwidth over a network and requests the bandwidth reservation unit 353 to reserve the bandwidth if the request bandwidth is determined to exist. The bandwidth reservation unit 353 reserves bandwidth requested by the bandwidth negotiation unit 352. If a network does not have the requested bandwidth, the bandwidth information transmission unit 3512 transmits negotiation request information D1 to the terminal 170 in order to request data buffering and receives information (D2) on buffering negotiation and the results from the terminal 170. The bandwidth information transmission unit 3512 transmits information (C) on the results of bandwidth negotiation and reservation to the information providing server 130 based on the negotiation results by the bandwidth negotiation unit 352 and the information on buffering negotiation and the results received from the terminal 170.

If the step of setting up a call is successfully performed by the bandwidth negotiation unit 352 and the bandwidth reservation unit 353, a display information transmission unit 3511 of the information transmission unit 351 transmits the display information A2 received from the information providing server 130 to the terminal 170 and thus performs a service.

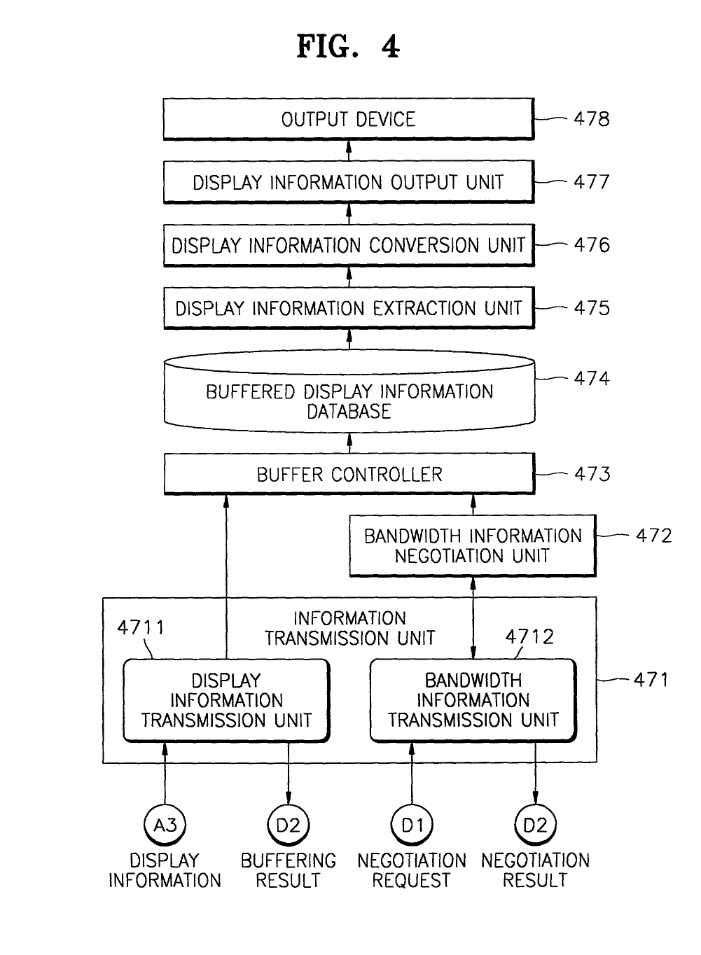

FIG. 4 is a block diagram illustrating the structure of the terminal 170 shown in FIG. 1. Referring to FIG. 4, the terminal 170 includes an information transmission unit 471, which sends/receives information to/from the information transmission server 150 over a network; a bandwidth information negotiation unit 472, which compensates for bandwidth that cannot be reserved in the information transmission server 150; a buffer controller 473, which receives request for buffering from the bandwidth information negotiation unit 472 and controls data buffering to compensate for the bandwidth that cannot be reserved in the information transmission server 150; a display information database 474, which stores received display information; a display information extraction unit 475, which extracts the display information from the display information database 474; a display information conversion unit 476, which converts the display information into information of a predetermined type that is appropriate for outputting; a display information output unit 477, which outputs the converted display information as a signal requested by an output device 478; and the output device 478, which provides a display service to a user using the display information.

In a step of setting up a call, a bandwidth information transmission unit 4712 of the information transmission unit 471 receives the negotiation request information D1, which is a request for buffering data to compensate for bandwidth that cannot be reserved on a network of the information transmission server 150, from the information transmission server 150 and transfers the negotiation request information D1 to the bandwidth information negotiation unit 472. The bandwidth information negotiation unit 472 receives the buffering negotiation request and requests the buffer controller 473 to perform data buffering to compensate for bandwidth that cannot be reserved on a network. The buffer controller 473 receives a predetermined amount of display information A3 via a display information transmission unit 4711 of the information transmission unit 471 and buffers data in the display information database 474. The display information transmission unit 4711 transmits information D2 on buffering and the results to the information transmission server 150. The bandwidth information transmission unit 4712 transmits the information D2 on the results of negotiation from the terminal 170 to the information transmission server 150.

If bandwidth negotiation and reservation by the information transmission server 150, and data buffering by the terminal 17 are successfully completed, the display information transmission unit 4711 of the information transmission unit 471 receives the display information A3 transmitted from the information transmission server 150 and transfers the display information A3 to the buffer controller 473. The buffer controller 473 temporarily stores the display information A3 in the display information database 474. The display information extraction unit 475 extracts the display information stored in the display information database 474 and transfers the display information A3 to the display information conversion unit 476. The display information conversion unit 476 converts the display information into information of a predetermined type that is appropriate for outputting and transfers the converted display information to the display information output unit 477. The display information output unit 477 transfers a signal requested by the output device 478 to the output device 478. The output device 478 provides a display service to a user.

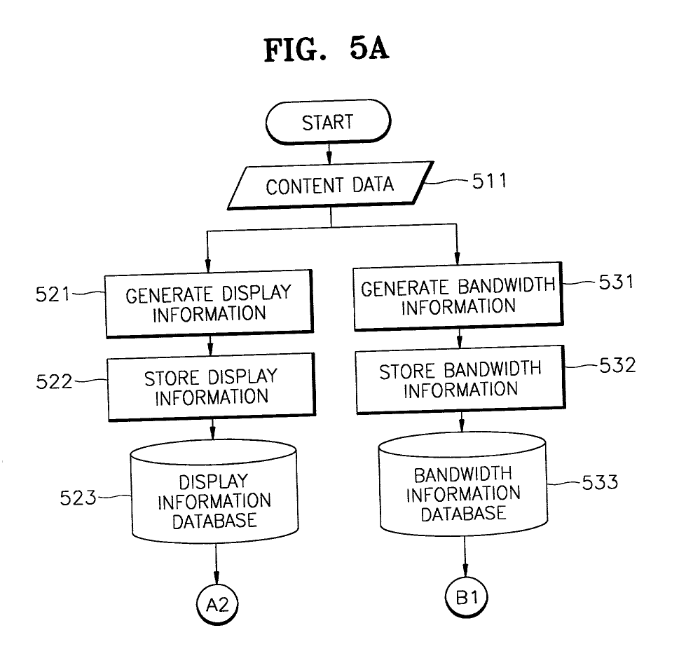

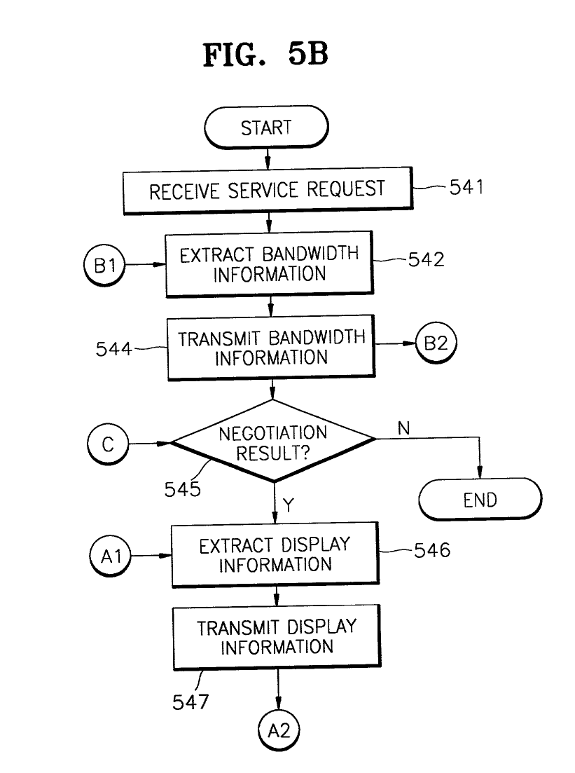

FIGS. 5A and 5B are flowcharts illustrating operation of the information providing server 130 according to a preferred embodiment of the present invention. The information providing server 130 receives multimedia content data from an input device in step 511. The information providing server 130 generates and stores display information based on the data received from the input device in steps 521 through 523. The information providing server 130 generates and stores bandwidth information based on the data received from the input device in steps 531 through 533.

A display information generation unit generates display information, which is compressed and converted into a MPEG or AVI format from the input data, in step 521. Next, the display information is stored in a display information database 523 in step 522. Bandwidth information is generated by a bandwidth information generation unit based on the display information generated and stored by the information providing server 130 in step 531. Next, the bandwidth information is stored in a data information database 533 in step 532. The steps of generating and storing the display information and the bandwidth information based on the multimedia content data are performed by the information providing server 130 in an offline state.

Referring to FIG. 5B, the information providing server 130 continuously monitors whether or not an information service request is received from a user, with the use of a listener. If a service request is received from a user in step 541, requested bandwidth information B1 concerning a service requested by a user is extracted by bandwidth information database interface in step 542. Requested bandwidth information B2 of the requested service is transmitted to the information transmission server 150 by bandwidth information transmission interface in step 544. If information C on the results of bandwidth negotiation is received from the information transmission server 150 and the bandwidth negotiation is successfully performed in step 545, display information A1 is extracted by a display information database interface, and display information A2 is transmitted to the information transmission server 150 by a display information transmission interface in step 547.

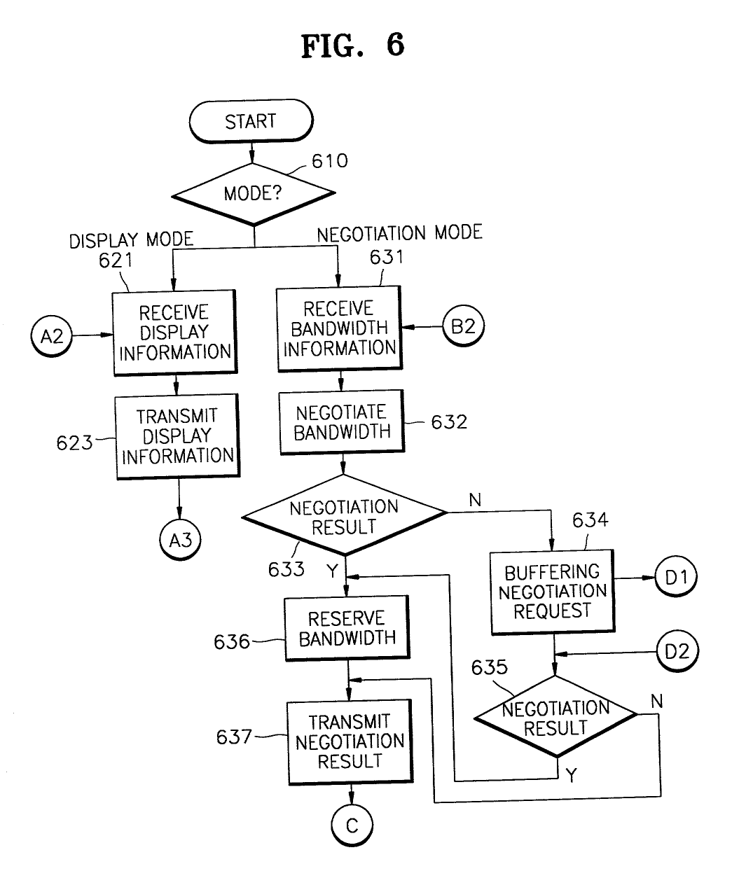

FIG. 6 is a flowchart illustrating operation of the information transmission server 150 according to a preferred embodiment of the present invention. The information transmission server 150 continuously monitors whether a request is received from the information providing server 130, using a listener. If a request is received from the information providing server 130, the information transmission server 150 determines whether the request is transmission of display information (display mode) or bandwidth negotiation (negotiation mode) in step 610. In the display mode, the information transmission server 150 receives the display information A2 from the information providing server 130 via a display information transmission interface in step 621 and transmits display information A3 to the terminal 170 via the display information transmission interface in step 623.

In the negotiation mode, in which the information transmission server 150 receives bandwidth negotiation request, requested bandwidth information B2 is received from the information providing server 130 via a bandwidth information transmission interface in step 631 and bandwidth negotiation is performed in step 632. If the bandwidth negotiation is successfully completed in step 633, in other words, if the bandwidth requested by the information providing server 130 is available on a network, the bandwidth requested by the information providing server 130 is reserved in step 636, and information C on the results of the bandwidth negotiation is transmitted to the information providing server 130 via a bandwidth negotiation transmission interface in step 637.

On the other hand, if the bandwidth negotiation is not successfully completed in step 633, negotiation request information D1 for requesting display information concerning bandwidth that cannot be reserved on a network to be buffered is transmitted to the terminal 170 via the bandwidth information transmission interface. The information transmission server 150 receives information D2 on buffering negotiation and the results from the terminal 170 via the bandwidth information transmission interface. If buffering negotiation is successfully completed in the terminal 170, the information transmission server 150 reserves bandwidths necessary for remaining display information, except for display information to be buffered in the terminal 170, in step 636 and transmits information C on the results of the negotiation to the information providing server 130 in step 637. If the buffering negotiation is not successfully completed in the terminal 170, the information transmission server 150 transmits information C on a failure in the negotiation in step 637.

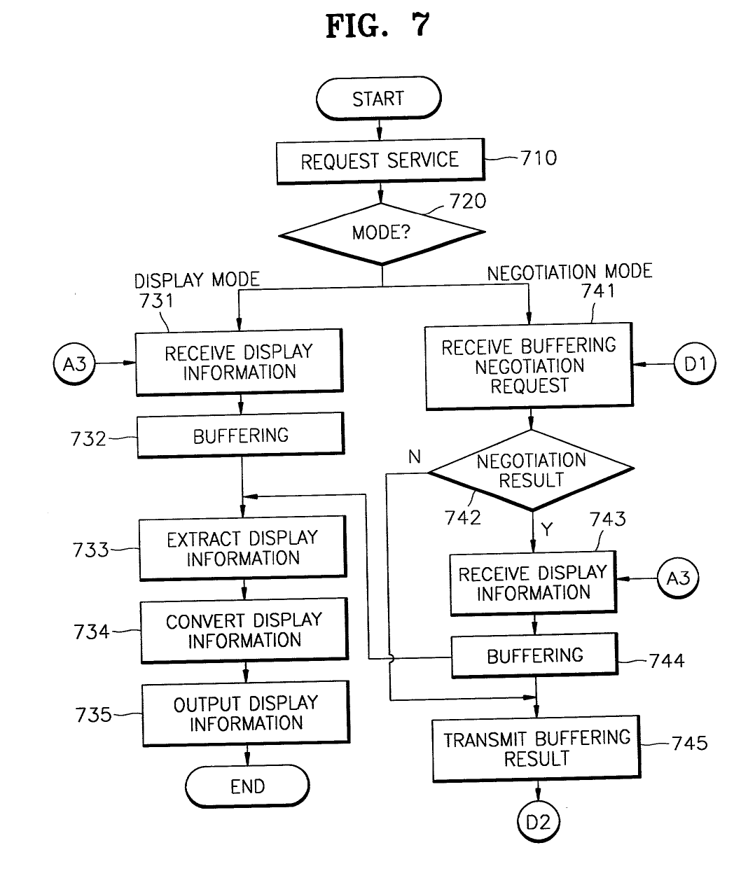

FIG. 7 is a flowchart illustrating operation of the terminal 170 according to a preferred embodiment of the present invention. Referring to FIG. 7, a user transmits a request for a multimedia service to the information providing server 130 via the terminal 170 in step 710. Next, the terminal 170 continuously monitors information transmitted from the information transmission server 150 using a listener and determines whether the information is display information (display mode) or buffering negotiation request information (negotiation mode) in step 720.

If the information transmitted from the information transmission server 150 is negotiation request information D1 (negotiation mode), the information is received via a bandwidth information transmission interface in step 741, in which case bandwidth negotiation is not successfully performed in the information transmission server 150 and thus buffering negotiation request is transmitted to the terminal 170. If buffering negotiation is successfully performed in the terminal 170, display information A3 is received from the information transmission server 150 via a display information reception interface in step 743 and buffers in a buffer display information corresponding to bandwidth that cannot be reserved on a network in step 744. When the buffering is completed, information D2 on the buffering results is transmitted to the information transmission server 150 via a bandwidth negotiation interface in step 745. If the buffering is not successfully performed in the terminal 170 in step 742, the information D2 on the buffering results is transmitted to the information transmission server 150 without performing buffering in step 745.

In a display mode, the terminal 170 receives display information A3 transmitted from the information transmission server 150 via a display information transmission interface in step 731. The display information A3 is buffered in a buffer in step 732. As a result of the buffering, a predetermined amount of the display information is buffered. The display information stored in the buffer is appropriately controlled and extracted in step 733. The extracted display information A3 is converted into information of a predetermined type in step 734 and is output to a user via an output device in step 735.

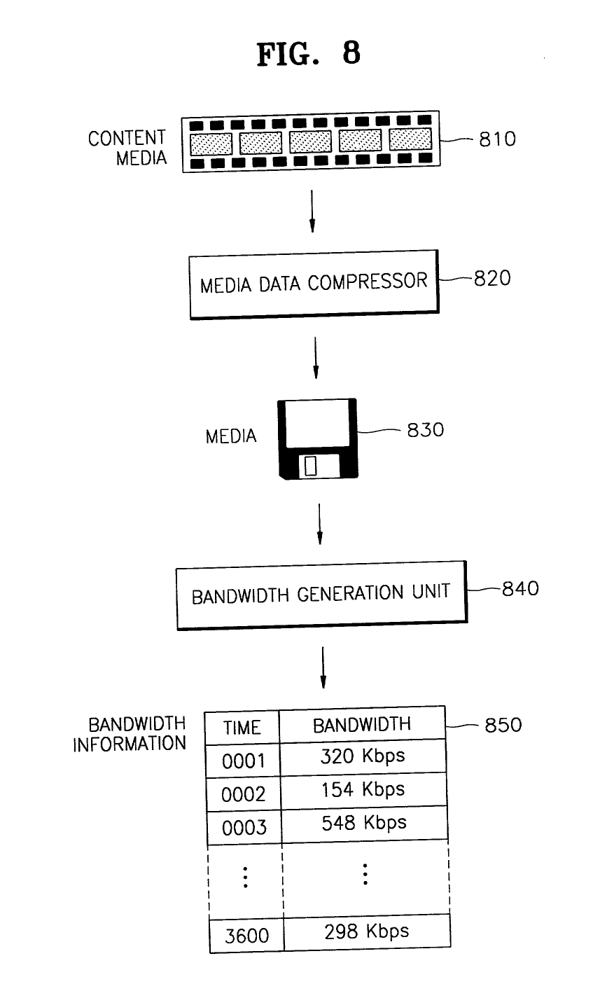

FIG. 8 is a view illustrating the functions of the bandwidth information generation unit 2322 of the information providing server 130. The input device 110 reads multimedia content data stored in content media 810, a media data compressor 820 compresses the data in a JPEG, MPEG, or AVI format, and media 830 containing the compressed data is produced. The bandwidth information generation unit 840 of the information providing server 130 reads the compressed data from the media 830 and generates bandwidth information 850 corresponding to display information. The bandwidth information 850 contains relations between a predetermined order of time and bandwidth corresponding thereto.

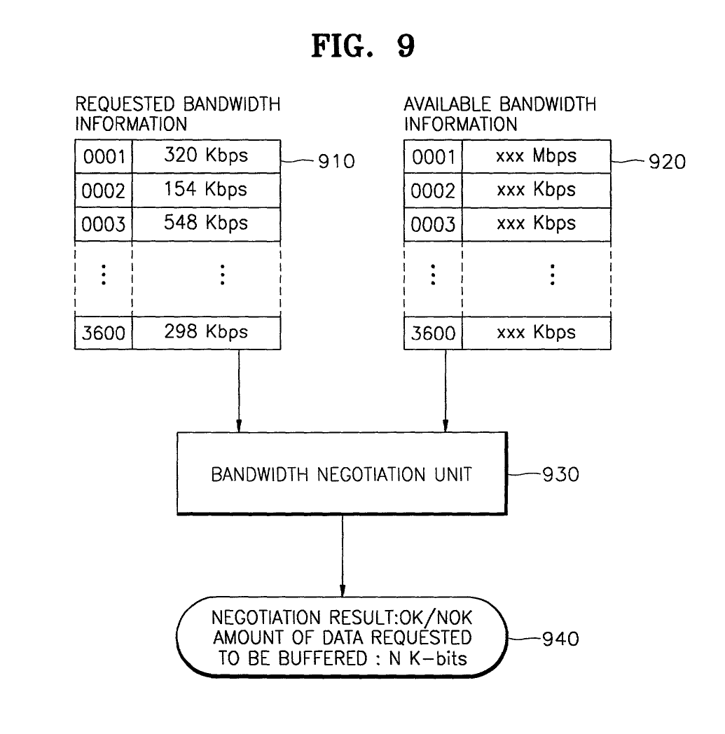

FIG. 9 is a view illustrating the functions of the bandwidth negotiation unit 352 of the information transmission server 150. The information transmission server 150 includes information 920 on the available bandwidth on a network and receives requested bandwidth information 910 with respect to the requested bandwidth necessary for providing a service from the information providing server 130. The bandwidth negotiation unit 930 determines whether or not the bandwidth requested by the requested bandwidth information 910 can be accepted on the network based on the information 920 on available bandwidth and performs bandwidth negotiation. Information on the results of the negotiation is generated depending on whether the bandwidth requested by the information providing server 130 can be accepted on the network. In a case where the network cannot accept the bandwidth requested by the information providing server 130, the amount of data to be buffered in the terminal 170 is calculated in step 940.

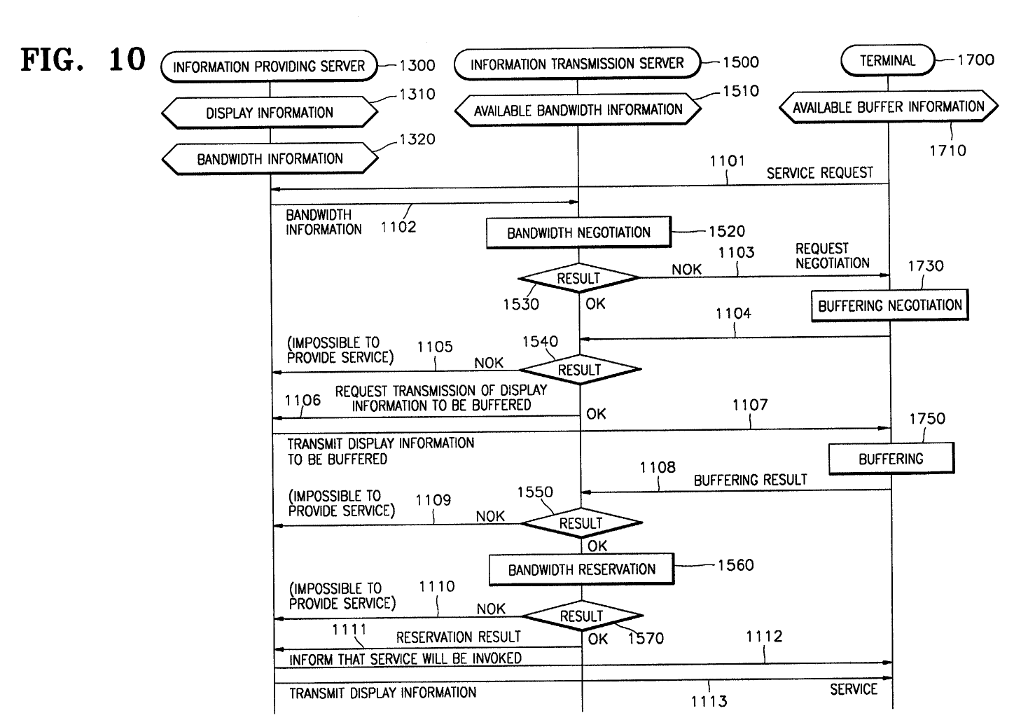

FIG. 10 is a flowchart illustrating operation of the communication system shown in FIG. 1. An information providing server 1300 generates display information 1310 and bandwidth information 1320 and stores the display information 1310 and the bandwidth information 1320 in their respective databases. An information transmission server 1500 generates and stores available bandwidth information 1510 concerning bandwidth, which can be accepted on a network. A terminal 1700 generates and stores available buffer information 1710 concerning the buffering capacity of a buffer.

A user transmits information on a service request to the information providing server 1300 using an application program in the terminal 1700 in step 1101. If the information providing server 1300 receives the service request information, requested bandwidth information with respect to bandwidth necessary for a predetermined service requested by the user is transmitted to the information transmission server 1500 in step 1101. If the information transmission server 1500 receives the requested bandwidth information from the information providing server 1300, the information transmission server 1500 performs bandwidth negotiation based on the results of comparing information on available bandwidth on network of the information transmission server 1500 with the requested bandwidth information in step 1520. If the bandwidth negotiation is successfully performed in step 1530, the information transmission server 1500 reserves bandwidth and transmits information on the results of the bandwidth reservation to the information providing server 1300 in step 1111. The information providing server 1300, to which completion of call setup is informed, informs the terminal 1700 that the service requested by the user will be invoked in step 1112 and transmits display information to the terminal 1700 in step 1113. The terminal 1700 provides the multimedia service requested by the user based on the display information. The processes described above are performed in a case where a network can accept all bandwidth necessary for transmitting display information for a service, and thus it is possible to smoothly transmit the display information from the information providing server 130 to the terminal 1700 over the network without the need of an additional buffering process.

On the other hand, if the bandwidth negotiation is not successfully completed in the information transmission server 1500 in step 1530, in other words, if a network cannot accept all the bandwidth necessary for a service to be provided to a user, the information transmission server 1500 transmits information on a request for buffering display information that cannot be accepted on the network to the terminal 1700 in step 1103. The terminal 1700 performs buffering negotiation on whether or not data necessary for compensating for the bandwidth that cannot be reserved on the network can be buffered in a buffer in step 1750. The buffering negotiation is performed by comparing the available capacity of the buffer based on available buffer information and the amount of data requested to be buffered. If information on the results of the buffering negotiation are transmitted from the terminal 1700 to the information transmission server 1500 in step 1104, the information transmission server 1500 determines whether or not the buffering negotiation is successfully completed in step 1540. If the buffering negotiation is determined not to be successfully completed in step 1540, information on which a service cannot be provided to a user is transmitted to the information providing server 1300 in step 1105.

If buffering can be performed in the terminal 1700, the information transmission server 1500 requests the information providing server 1300 to transmit display information to be buffered in the terminal 1700 in step 1106. Next, the information providing server 1300 transmits the display information to be buffered in the terminal 1700 in response to the display information transmission request transmitted from the information transmission server 1500 in step 1107. The terminal 1700 receives the display information to be buffered and allows the display information to be buffered in a buffer in step 1750. Next, the terminal 1700 transmits the results of the buffering to the information transmission server 1500 in step 1108. If the buffering is failed, the information transmission server 1500 transmits information on which a service cannot be provided to a user, to the information providing server 1300 in step 1109. If the buffering is successfully completed, the information transmission server 1500 performs bandwidth reservation in step 1560. If the bandwidth reservation is successfully completed, the information transmission server 1500 transmits information on the results of the reservation to the information providing server 1300 in step 1111, thus completing call setup. The information providing server 1300, to which completion of call setup is informed, informs the terminal 1700 that a service will be invoked in step 1112 and transmits display information over a network in step 1113.

The communication system according to the present invention may be applied to various non-real-time multimedia content streaming services using a communication network, which requires a large storage capacity as well as VOD systems described above, as an embodiment of the present invention.

The present invention may be realized into readable codes recorded in recording media, which can be read out by a computer. The recording media, which can be read out by a computer, include all kinds of recording devices in which data that can be read by a computer system are stored, such as ROMs, RAMs, CD-ROMs, magnetic tapes, floppy disks, or optical data storages. Alternatively, the recording media include devices realized in a carrier-wave type, for example, devices for transmitting data through the Internet. In addition, the recording media, which can be read by a computer, may be distributed to computer systems connected to one another over a network, and thus codes that can be read by a computer can be stored in the recording media in the manner of distribution and can be performed.

As described above, according to the present invention, it is possible to realize a non-real-time VOD system for seamlessly performing high-quality multimedia streaming services, which require a large storage capacity, over a network having limited bandwidth. Accordingly, it is possible to obtain more clients through the maximization and optimization of the quality of services to be provided to users and actively obtain bandwidth in accordance with conditions on bandwidth occupation over a network. It is possible to maximize and optimize usage of network resources by precisely performing bandwidth negotiation and reservation. In addition, it is possible to allow users to seamlessly receive information through optimal buffering and pay money only for the amount of appropriate and precise bandwidth usage.

The present invention is appropriate for non-real-time VOD systems, which seamlessly perform high-quality multimedia streaming services that require a large storage capacity using limited network bandwidth. In addition, the present invention will help high-quality multimedia content requiring more bandwidth and high quality multimedia content streaming services, the size of which varies every time, to be provided to users.

While this invention has been particularly shown and described with reference to preferred embodiments thereof, it will be understood by those skilled in the art that various changes in form and details may be made therein without departing from the a spirit and scope of the invention as defined by the appended claims.

What is claimed is:

1. An information providing system comprising:
an information providing server, which stores display information and bandwidth information requested for transmission of the display information, and transmits the display information and the bandwidth information in response to the request of the user;
an information transmission server, which performs bandwidth negotiation and bandwidth reservation based on information on available bandwidth on the network using the bandwidth information transmitted from the information providing server and requests buffering for bandwidth that cannot be reserved; and
a terminal which receives the display information from the information providing server in response to the buffering request received from the information transmission server, buffers the display information, and displays the display information transmitted from the information providing server over the network together with the buffered display information after call setup.

2. An information providing device comprising:
an information generation unit which generates display information and bandwidth information requested for transmission of the display information
an information extraction unit which extracts display information to be provided corresponding to a service requested by a user and bandwidth information requested for the service request;
bandwidth information transmission unit which transmits the requested bandwidth information over a network and receives information on the results of bandwidth reservation; and
a display information transmission unit which transmits the display information over the network based on the information on the results of bandwidth reservation.

3. The information providing device of claim 2 further comprising a bandwidth negotiation unit which performs bandwidth reservation based on the requested bandwidth information and the information on available bandwidth over the network and requests a terminal to perform buffering if the bandwidth reservation is not successful.

4. An information transmission device comprising:
a bandwidth information transmission unit which receives requested bandwidth information necessary for display information to be transmitted over a network and transmits information on the results of bandwidth negotiation with respect to the requested bandwidth information;
a bandwidth negotiation unit which determines whether or not bandwidth can be reserved by comparing the requested bandwidth information with information on available bandwidth over the network and requests a terminal to perform data buffering if there is bandwidth that cannot be reserved over the network;
a bandwidth reservation unit which, if possible, reserves bandwidth requested by the requested bandwidth information and, if not possible, reserves the bandwidth requested by the requested bandwidth information except for bandwidth requested to be buffered in the terminal; and
a display information transmission unit which transmits display information to be buffered in the terminal and transmits display information to the terminal with the bandwidth reserved by the bandwidth reservation unit after call setup.

5. A terminal, which receives information over a network in response to the request of a user, the terminal comprising:
a bandwidth negotiation unit which determines whether or not data requested to be buffered can be buffered if bandwidth reservation is not successful over the network in response to the request of the user and transmits the result of the determination;
a display information transmission unit which receives and stores display information necessary for the requested buffering, and receives and stores display information necessary for providing a service after call setup; and
an output unit which extracts and outputs the stored display information.

6. A method of providing information comprising:
receiving a request for providing an information service from a user's terminal;
extracting display information to be provided to a user corresponding to the service request and bandwidth information requested for transmission of the display information;
determining whether or not it is possible to reserve bandwidth by comparing the requested bandwidth information with information on available bandwidth over a network;
providing the service by transmitting the display information to the user's terminal after call setup, if bandwidth reservation is successful;
requesting the user's terminal to perform data buffering and transmitting a part of the display information to the user's terminal so as to be buffered, if it is determined that bandwidth that cannot be reserved exists; and
providing the service by setting up a call with bandwidth that can be reserved over the network after the buffering is completed and transmitting the rest of the display information to the user's terminal.

7. A method of providing information comprising:
(a) receiving content data for providing a service;
(b) generating and storing display information and bandwidth information corresponding to the amount of display information requested at each time span;
(c) extracting bandwidth information necessary for the service in response to a service request and requesting a network to negotiate bandwidth; and
(d) receiving information on the results of the bandwidth negotiation from the network and transmitting display information corresponding to the service using the reserved bandwidth over the network.

8. The method of claim 7, wherein steps (a) and (b) are performed in an offline state so that the display information and the bandwidth information can be stored in a database, and steps (c) and (d) are performed in an online state in response to the request of a user.

9. A recording medium, which can be read out by a computer, in which a program requested to perform any of the methods of claims 6 through 8 are recorded.
